(19) United States
(12) Patent Application Publication
(10) Pub. No.: US 2014/0113025 A1
(43) Pub. Date: Apr. 24, 2014

(54) HEAT-RESISTANT COMPOSITION FOR ANIMALS, COMPRISING AN ENZYMATIC MIXTURE

(71) Applicants: Pierre Dalibard, Gif sur Yvette (FR); Francis Pierre, Neris les Bains (FR); Nicolas Besse, Montrouge (FR)

(72) Inventors: Pierre Dalibard, Gif sur Yvette (FR); Francis Pierre, Neris les Bains (FR); Nicolas Besse, Montrouge (FR)

(21) Appl. No.: 13/966,689

(22) Filed: Aug. 14, 2013

Related U.S. Application Data
(63) Continuation of application No. 12/667,251, filed on May 12, 2010, now abandoned.

(30) Foreign Application Priority Data
Jul. 20, 2007 (FR) 0705276

(51) Int. Cl. A23K 1/165; A23K 1/00; A23K 1/18

(52) U.S. Cl. CPC A23K 1/1656; A23K 1/1826; A23K 1/002; A23K 1/004
USPC 426/18; 426/61

(57) ABSTRACT

The invention relates to a heat-resistant composition for animals in the form of a granular powder, comprising: a) a liquid mixture of at least two enzymes; b) a medium selected from the group comprising wheat flour, starch, gypsum, maltodextrin, and corn cobs; and c) a coating agent selected from the group comprising cellulose and the derivatives thereof, chitin, carrageenan, sodium alginate, vegetable gums, gums obtained using a fermentation process, and starches and derivatives.

The present invention relates to a composition in the powder form comprising a mixture of enzymes.

Enzymes have been used for a long time in various industrial applications, in particular in animal nutrition. In this case, enzymes improve the digestibility of the plant sources and thus allow the farmed animals to digest their feeds more efficiently.

Enzymes are produced by a great variety of organisms: plants, animals and in particular microorganisms, that is to say any mono- or multicellular organism, in particular chosen from bacteria, yeasts and fungi.

Patent application EP 1 007 743 describes in particular a mixture of enzymes obtained from Penicillium funiculosum formulated in the liquid form or in the powder form and intended for the feeding of animals.

The enzymes are added to the feeds in a liquid form by spraying or they are incorporated in the feeds in a mixer and then the feeds are granulated in a pellet mill

A significant part of animal feeds are subjected to a heat treatment for reasons of hygiene (microbiological quality) or of ease of consumption by the animals (presentation in the crumb or granule form). These heat treatments are based on the use of steam at a more or less high temperature, optionally in combination with an agglomeration (pellet mill).

Nevertheless, it proves to be the case that enzymes are proteins which are by nature sensitive to the temperature. A loss in enzymatic activity is observed when high temperatures are used.

An object of the present invention is to provide a composition in the powder form comprising an enzymatic mixture which is heat-resistant.

### DESCRIPTION OF THE INVENTION

The present invention relates to a heat-resistant composition for animals in the granular powder form comprising:

a) a mixture in the liquid form of at least two enzymes,

b) a support chosen from the group consisting of wheat meal, starch, gypsum, maltodextrin and corncobs, and

c) a coating agent chosen from the group consisting of cellulose and its derivatives, chitin, carrageenan, sodium alginate, plant gums, gums obtained by fermentation and starches and derivatives.

According to one embodiment, the mixture in liquid form of at least two enzymes is obtained from the fermentation of just one microorganism. According to another embodiment, the mixture in liquid form of at least two enzymes is obtained from the fermentation of two different microorganisms. Advantageously, the mixture in liquid form of at least two enzymes is a filtered and concentrated fermentation must obtained from at least one microorganism.

According to another embodiment, the composition comprises:

a) from 15 to 50% by weight of said mixture of at least two enzymes,

b) from 25 to 60% by weight of said support,

c) from 25 to 60% by weight of said coating agent.

According to one embodiment, the at least two enzymes are chosen from the group consisting of a xylanase, a β-glucanase, a cellulase, a pectinase, a phytase and a protease. Advantageously, the at least two enzymes are chosen from the group consisting of phytase, endo-1,4-β-xylanase, α-arabinofuranosidase, β-xylosidase, feruloyl esterase, endo-1,5-α-arabinanase, endo-1,3(4)-β-glucanase, laminarinase, endo-1,4-β-glucanase, cellobiohydrolase, β-glucosidase, polygalacturonase, pectin esterase, rhamnogalacturonase, aspartic protease, metalloprotease, endo-1,4-β-mannanase, β-mannosidase and α-galactosidase.

According to one embodiment of the invention, the microorganism is Penicillium funiculosum, deposited at the IMI (International Mycological Institute, Bakeham Lane, Englefield Green, Egham, Surrey, TW20 9TY, UK) on Mar. 24 1998 under the number IMI 378536.

According to one embodiment of the invention, the coating agent is carboxymethylcellulose or ethylcellulose.

According to one embodiment of the invention, the composition is capable of being obtained by the process comprising the following stages:

a) codrying the following compounds:
a support chosen from the group consisting of wheat meal, starch, gypsum, maltodextrin and corncobs, and
a mixture in the liquid form of at least two enzymes,

so as to obtain an intermediate base,

b) granulation by impregnation of the intermediate base with a coating agent chosen from the group consisting of cellulose and its derivatives, chitin, carrageenan, sodium alginate, plant gums, gums obtained by fermentation and starches and derivatives,

c) coating the impregnated intermediate base with a coating agent chosen from the group consisting of cellulose and its derivatives, chitin, carrageenan, sodium alginate, plant gums, gums obtained by fermentation and starches and derivatives, and

d) drying.

The present invention also relates to a nutritional additive for animals in the powder form comprising:

a) a mixture in the liquid form of at least two enzymes,

b) a support chosen from the group consisting of wheat meal, starch, gypsum, maltodextrin and corncobs, and

c) a coating agent chosen from the group consisting of cellulose and its derivatives, chitin, carrageenan, sodium alginate, plant gums, gums obtained by fermentation and starches and derivatives.

The present invention also relates to an animal feed, characterized in that it comprises a nutritional base for animals and a nutritional additive as claimed in claim 10.

Finally, the present invention relates to the use of a coating agent chosen from the group consisting of cellulose and its derivatives, chitin, carrageenan, sodium alginate, plant gums, gums obtained by fermentation and starches and derivatives in preparing a nutritional additive for animals comprising a mixture of at least two enzymes obtained from the fermentation of just one microorganism. Advantageously, the coating agent is carboxymethylcellulose.

### Composition

The present invention thus relates to a heat-resistant composition for animals in the granular powder form.

“Heat-resistant composition” is understood to mean a composition which is resistant to heat. One of the important properties of the composition according to the present invention is that of being resistant to heat. This is because the composition according to the present invention will be subjected to a heat treatment intended, on the one hand, to produce a microbiological quality and, on the other hand, to formulate the composition in order to be able to be more easily used by the breeders and consumed by the animals. The term “pelletization process” is used. Pelletization is an agglomeration of feeds in the form of small granules. These granules are not friable, unlike agglomerates. After pelletization, pellets are obtained. The pellets are granules with a size of from 1.5 to 6 mm in diameter and from 1.5 to 4 cm in length. Use is made, for the pelletization, for example, of pellet mills, the operation of which is based on the use of steam at a more or less high temperature. For example, the composition withstands a temperature of greater than 80° C., 85° C. or 90° C.

“Granular powder” is understood to mean a powder which exhibits a certain particle size.

According to the present invention, the particle size requirements of the composition obtained are as follows:

| Size of the particles | Percentage in the mixture |
|---|---|
| Greater than 800 μm | < or = to 1% |
| Between 400 and 160 μm | > or = to 40%, preferably < or = to 50% |
| Less than 200 μm | < or = to 15%, preferably > or = to 12% |
| Less than 100 μm | < or = to 10%, preferably < or = to 5% |

Advantageously, the median diameter of the particles of the product lies between 150 and 400 μm. “Median diameter” is understood to mean the size of the particles of the product at which 50% of the sample has a smaller size and 50% of the sample has a bigger size.

The composition of the present invention is intended for animals. In other words, the composition according to the present invention is suitable for use in animal nutrition.

“Animal” is understood to mean more particularly farmed animals and especially grazing animals (in particular bovines reared for meat, milk, cheese and leather; ovines reared for meat, wool and cheese; caprines; or porcines), rabbits, poultry (chickens, hens, turkeys, ducks, geese and others), aquatic animals (for example fish, prawns, oysters and mussels) or leisure and companion animals (in particular horses, dogs or cats). Bovines, or Bovinae, constitute a subfamily of the Bovidae, multistomached ruminant mammals, which comprises several important species of farmed animals (dairy breeds, meat breeds and mixed breeds).

“Composition suitable for use in animal nutrition” is understood to mean a composition having characteristics such that it is suitable for animal nutrition. The characteristics essential for use in animal nutrition are in particular the pH at which and the temperature at which the composition comprising the mixture of enzymes is active. This is because the pH of the digestive system of the animals is acidic and it is therefore essential for the enzymes to remain active at this pH in order to retain their activities.

According to one embodiment of the present invention, the composition retains the expected enzymatic activities at an acidic pH, for example at a pH of less than 7, preferably less than 5.

The present invention thus relates to a heat-resistant composition for animals in the granular powder form comprising:

a) a mixture in the liquid form of at least two enzymes,

b) a support chosen from the group consisting of wheat meal, starch, gypsum, maltodextrin and corncobs, and

c) a coating agent chosen from the group consisting of cellulose and its derivatives, chitin, carrageenan, sodium alginate, plant gums, gums obtained by fermentation and starches and derivatives.

Enzymes are produced by a great variety of organisms: plants, animals and especially microorganisms. “Microorganism” is understood to mean any mono- or multicellular organism chosen in particular from bacteria, yeasts and fungi. Advantageously, the yeasts are chosen from, for example, Pichia pastoris, Saccharomyces cerevisae, Yarrowia lipolytica and Schwanniomyces occidentalis. The fungi are, for example, chosen from Aspergillus species, Trichoderma species and Penicillium species, preferably from Penicillium funiculosum, Trichoderma reesei, Aspergillus niger, Aspergillus awamori, Aspergillus kawachii and Trichoderma koningii.

According to one embodiment, the mixture in the liquid form of at least two enzymes is obtained from the fermentation of just one microorganism. Advantageously, the mixture in a liquid form of at least two enzymes is a filtered and concentrated fermentation must obtained from just one microorganism.

According to another embodiment of the present invention, the microorganism used originates from a genetically unmodified strain of microorganism in the isolated state which produces at least two enzymatic activities. Alternatively, it can be a host organism transformed with a polynucleotide, an expression cassette and/or a vector.

In one embodiment of the invention, the microorganism is a Penicillium funiculosum strain in which an enzyme is expressed or overexpressed. In another embodiment, the host organism is a Debaryomyces castellii strain in which an enzyme is expressed or overexpressed. In yet another embodiment, the host organism is a Ruminococcus gnavus strain in which an enzyme is expressed or overexpressed.

According to one embodiment of the invention, the microorganism is Penicillium funiculosum deposited at the IMI (International Mycological Institute, Bakeham Lane, Englefield Green, Egham, Surrey, TW20 9TY, UK) on Mar. 24 1998 under the number IMI 378536.

According to another embodiment, the composition comprises from 15 to 50% by weight of said mixture of at least two enzymes, preferably from 20 to 40% by weight.

According to another embodiment of the present invention, the heat-resistant composition for animals in the granular powder form comprises a mixture in the liquid form of at least three enzymes, four enzymes, eight enzymes or ten enzymes.

According to one embodiment, the at least two enzymes are chosen from the group consisting of a xylanase, a β-glucanase, a cellulase, a pectinase, a phytase and a protease. Advantageously, the at least two enzymes are chosen from the group consisting of phytase, endo-1,4-β-xylanase, α-arabinofuranosidase, β-xylosidase, feruloyl esterase, endo-1,5-α-arabinanase, endo-1,3(4)-β-glucanase, laminarinase, endo-1,4-β-glucanase, cellobiohydrolase, β-glucosidase, polygalacturonase, pectin esterase, rhamnogalacturonase, aspartic protease, metalloprotease, endo-1,4-β-mannanase, β-mannosidase and α-galactosidase.

The present composition also comprises a support. The support is chosen from the group consisting of wheat meal, starch, gypsum, maltodextrin and corncobs. The support is present in the composition at a content of between 25 and 60% by weight of the heat-resistant composition in the granular powder form.

Finally, the present composition comprises a coating agent. The coating agent is chosen from the group consisting of cellulose and its derivatives, chitin, carrageenan, sodium alginate, plant gums, gums obtained by fermentation and starches and derivatives. The plant gums are plant exudates which solidify by desiccation. Mention may be made, as indication of the gums which can be used in the present invention, of the following gums: gum arabic, karaya gum, gum tragacanth, guar gum or xanthan gum.

“Starches and derivatives” is understood to mean any polysaccharide formed of the combination of two polymers: amylose and amylopectin. According to the present invention, the starch can occur in the powder form or in the paste form. By way of indication, it can be native wheat starch, native corn starch, native rice starch or potato meal. The same starches treated physically, for example pregelatinized, may also be involved.

According to one embodiment of the invention, the coating agent is carboxymethylcellulose or ethylcellulose.

The coating agent is present in the heat-resistant composition in the granular powder form at a content of between 25 and 60% by weight, preferably between 30 and 58% by weight.

According to another subject matter of the present invention, the composition is capable of being obtained by the process comprising the following stages:

a) codrying the following compounds:
a support chosen from the group consisting of wheat meal, starch, gypsum, maltodextrin and corncobs, and
a mixture in the liquid form of at least two enzymes,

so as to obtain an intermediate base,

b) granulation by impregnation of the intermediate base with a coating agent chosen from the group consisting of cellulose and its derivatives, chitin, carrageenan, sodium alginate, plant gums, gums obtained by fermentation and starches and derivatives,

c) coating the impregnated intermediate base with a coating agent chosen from the group consisting of cellulose and its derivatives, chitin, carrageenan, sodium alginate, plant gums, gums obtained by fermentation and starches and derivatives, and

d) drying.

The coating agent, which is identical or different, is used during two successive stages of the process. This results in a powder exhibiting a novel aspect, in which the coating agent is found both inside and outside the granular powder. This confers advantageous properties on the powder.

The composition in the powder form exhibits good flowability. An example of a measurement protocol which makes it possible to evaluate the flowability of the powder is the determination of the angle of repose. This method is based on the determination of the angle at the base of the cone of fallen material obtained by passing the sample through a special funnel placed at a conventional height above a perfectly flat and horizontal plate. This method requires the following equipment: laboratory glassware and equipment, stainless steel funnel, the base of which has a diameter (d) of less than 6 mm (the funnel being attached to the support), stainless steel plate engraved with 4 straight lines forming, between one another, an angle of 45° and being perpendicular to the center of the funnel, and support made of stainless steel attached to the plate. The method consists in adjusting the height (H) between the plate and the base of the funnel to 40 mm, confirming the perpendicularity of the center of the funnel with the crossing point of the engraved straight lines, pouring the powder into the funnel, halting the feeding when the tip of the cone touches the base of the funnel, drawing on each engraved line a mark at the base of the silica cone formed, removing the silica and measuring the distance separating two marks on the same line for each of them.

The angle of repose for the fallen material, expressed in degrees, is given by the formula:

$$α = Arctg \frac{2 H}{D - d}$$

in which:
H: the height of the cone in mm (H=40)
d: internal diameter of the base of the funnel in mm (d=6 mm)
D: arithmetic mean of the 4 measurements in mm
α: angle of repose in degrees

According to the present invention, the composition in the powder form exhibits an angle of repose of between 20° and 50°, preferably between 20° and 45°.

Another example of a measurement protocol which makes it possible to evaluate the flowability of the powder is the measurement of the compressibility, according to the following formula:

$$Compressibility = \frac{\% ( tapped density - bulk density )}{tapped density}$$

According to the present invention, the composition in the powder form exhibits a compressibility index of between 0 and 40%, preferably between 0 and 20%.

The compositions in the powder form of the present invention can additionally comprise an active principle other than the mixture of enzymes or several active principles.

“Active principle” is understood to mean any substance having an established physiological activity in the animal. Food supplements in particular come within the category of active principle according to the invention. Food supplements for animals are products intended to be ingested, in supplementing the everyday diet, in order to overcome inadequate daily contributions of certain compounds. For example, it is known, generally, to supplement the food intakes of farmed animals with active principles so as to enhance the animal husbandry performance of the animals reared. They can in particular be vitamins, mineral salts, amino acids, trace elements, hormones or antibiotics.

### Process for the Preparation of the Composition in the Granular Powder Form

The process for the preparation of the abovementioned composition comprises the following stages:

a) codrying the following compounds:
at least one support chosen from the group consisting of wheat meal, starch, gypsum, maltodextrin and corncobs, and
at least one mixture in the liquid form of at least two enzymes obtained from just one microorganism,

in return for which an intermediate base is obtained,

b) granulation by impregnation of the intermediate base with a coating agent chosen from the group consisting of cellulose and its derivatives, chitin, carrageenan, sodium alginate, plant gums, gums obtained by fermentation and starches and derivatives,

c) coating the impregnated intermediate base with a coating agent chosen from the group consisting of cellulose and its derivatives, chitin, carrageenan, sodium alginate, plant gums, gums obtained by fermentation and starches and derivatives, and

d) drying.

The first stage of the process thus consists of a codrying of the enzymatic mixture, which occurs in the liquid form, with the support according to the invention. This stage can be carried out continuously on a drying tower by atomization. Codrying is carried out at a temperature which is not decomposing. The powder should be maintained at a temperature below 45° C. This stage results in a significant part of the enzymatic mixture in a liquid form being retained on the support. A microgranulated powder with a size of between 50 and 250 μm is obtained. The water content of the powder is less than 20%.

The second stage of the process consists of a granulation by impregnation of the intermediate base with a coating agent chosen from the group consisting of cellulose and its derivatives, chitin, plant gums, gums obtained by fermentation and starches and derivatives. It is a type of wet granulation which consists in carrying out, in a mixer, also known as granulator, equipped with a liquid addition system, a densification of the particles in combination with a granulation to give cohesion to the particles. This stage can be carried out continuously or batchwise.

The third stage of the process consists in depositing a satisfactory film of a coating agent chosen from the group consisting of cellulose and its derivatives, chitin, plant gums, gums obtained by fermentation and starches and derivatives. This coating agent can be the same as that used during the granulation stage or it can be different. This stage can be carried out continuously or batchwise, for example on a fluidized bed dryer. The amount of coating agent depends on the final particle size desired for the product.

The fourth stage consists in drying the final product. This drying can be carried out continuously on a fluidized bed or batchwise, so that the water content of the product is less than 10%, preferably less than 8%.

It is possible to add an intermediate stage between the second stage and the third stage. This stage consists in drying the granulated powder, continuously or batchwise.

It is also possible to add a sieving stage between the second stage and the third stage or after the optional stage of drying the granulated powder. Pelletization process

According to the present invention, the pelletization process comprises the following stages:

a) the heat-resistant composition in the granular powder form, on the one hand, and the nutritional base, on the other hand, are fed to a feeder,

b) the mixture is heated to a temperature of between 60 and 100° C., preferably between 70 and 90° C.,

c) said composition is pelletized in a granulating press, and

d) the pellets obtained are cut to the desired length,

e) the pellets obtained in stage d) are dried and cooled.

### Nutritional Additive for Animals

The present invention also relates to a nutritional additive in the powder form comprising:

a) a mixture in the liquid form of at least two enzymes,

b) a support chosen from the group consisting of wheat meal, starch, gypsum, maltodextrin and corncobs, and

c) a coating agent chosen from the group consisting of cellulose and its derivatives, chitin, carrageenan, sodium alginate, plant gums, gums obtained by fermentation and starches and derivatives.

### Animal Feed

The present invention also relates to an animal feed, characterized in that it comprises a nutritional base for animals and a nutritional additive as defined above.

The nutritional base comprises, for example, a mixture of wheat, soybean cake, extruded soya seeds, palm oil, calcium carbonate, dicalcium phosphate, salt or a premix comprising methionine.

### Use

A subject matter of the present invention also relates to the use of carboxymethylcellulose for preparing a nutritional additive for animals comprising a mixture of at least two enzymes obtained from the fermentation of just one microorganism.

Another subject matter of the present invention is the use of carboxymethylcellulose for preparing a nutritional additive for animals which is intended to improve the growth performance of the animals, for example to improve the feed conversion.

### DESCRIPTION OF THE FIGURES

FIG. 1 represents the respective particle sizes of a powder of the prior art and of a powder according to the present invention; on the abscissa, the diameter in μm; on the ordinate, the percentage in the product.

### EXAMPLE 1

A composition according to the invention was prepared according to the process of the present invention. It is provided in the powder form and comprises 55% of carboxymethylcellulose, 25% of wheat meal and 20% of concentrated filtered fermentation must obtained from the fermentation of Penicillium funiculosum IMI 378536, which comprises 19 enzymatic activities.

### 1. Codrying

475 kg/h of 28.7% DM (dry matter) enzymatic solution are sprayed at 165 bar and codried continuously over meal at the rate of 113 kg/h at low temperature. The distribution in the dry extract is thus as follows: 55% pure enzyme and 45% support, in the case in point meal.
146° C.: inlet air temperature
49° C.: outlet air temperature
40° C.: air temperature of the static bed
35° C.: air temperature of the vibro-fluidizer (first section)
27° C.: air temperature of the vibro-fluidizer (second section)

The microgranulated powder obtained in this stage exhibits the character of a powder without fines of less than 63 μm, which makes it a product capable of being handled in a second phase.

The mean particle size in D(v, 0.5) is 117 microns and the water content is 7.5%.

The product obtained at the end of this first stage is known as intermediate base.

### 2. Granulation by Impregnation

It is carried out in a mixer in the following way:
30 seconds of premixing of the ingredients, that is to say of 0.77 kg of CMC dry matter per kg of intermediate base dry matter,
120 seconds of addition of water at the rate of 0.18 kg of water per kg of intermediate base dry matter, with stirring,
120 seconds of final mixing.

The object of this stage is to obtain particles of the order of 150 to 200 μm on average, with a water content of 14%, while maintaining the product at less than 45° C. in order not to damage the enzymatic activities.

### 3. Intermediate Drying on a Fluidized Bed

The product is dried on a fluidized bed dryer at an inlet temperature of 55° C. and an outlet temperature of 25° C., in order not to damage the enzymatic activities. The intermediate base before coating then has a water content of 7 or 8%.

### 4. Coating

Between 7 and 7.5% of a CMC solution of low viscosity reheated before spraying to a temperature varying between 60 and 70° C. are sprayed.

The amount of solution deposited is 0.25 kg of CMC dry matter per kg of dry matter of product to be coated.

The powder obtained at this stage has a mean particle size of 300 to 400 μm and a water content of 10 to 11%.

The final product is then dried continuously on a fluidized bed or batchwise; the object in this case is to bring the product back to a water content of less than 10% and preferably of less than 8%.

The final product obtained has a water content of 7.6% and a density of 450 g/l.

### 5. Particle Size Measurement

The particle size was respectively measured for the following compositions:

The first composition is the product Rovabio™ Excel AP, which is provided in the powder form.

The second composition was prepared according to the process described above. It is thus a composition according to the invention which comprises 55% of carboxymethylcellulose, 25% of wheat meal and 20% of concentrated filtered fermentation must obtained from the fermentation of Penicillium funiculosum IMI 378536.

The particle sizes of the compositions are taken up in the following table:

| | % in the product | % in the product of the |
|---|---|---|
| Size of the particles | Rovabio ™ Excel AP | 2^{nd} composition |
| >800 μm | 0% | 0.5% |
| < than 800 μm and | 0.1% | 3.2% |
| >630 μm | | |
| < than 630 μm and | 0.4% | 11.4% |
| >500 μm | | |
| < than 500 μm and | 0.9% | 19.7% |
| >400 μm | | |
| < than 400 μm and | 2.2% | 24.9% |
| >315 μm | | |
| < than 315 μm and | 14.3% | 29.2% |
| >200 μm | | |
| < than 200 μm and | 15.1% | 6.4% |
| >160 | | |
| < than 160 μm and | 40.6% | 4.3% |
| >100 μm | | |
| <100 μm | 26.5% | 0.4% |
| Median diameter | 135 μm | 350 μm |
| Dispersion index | 0.5 | 0.4 |

It is found that the particle size of the second composition exhibits the advantage of comprising an amount of small particles which is lower than that of the product Rovabio™ Excel AP (composition in the granular powder form of the prior art). This low amount of small particles prevents problems of loss of products, of crosscontamination between the production system and the products themselves, of use of filtration and ventilation systems and of undesirable effects on health.

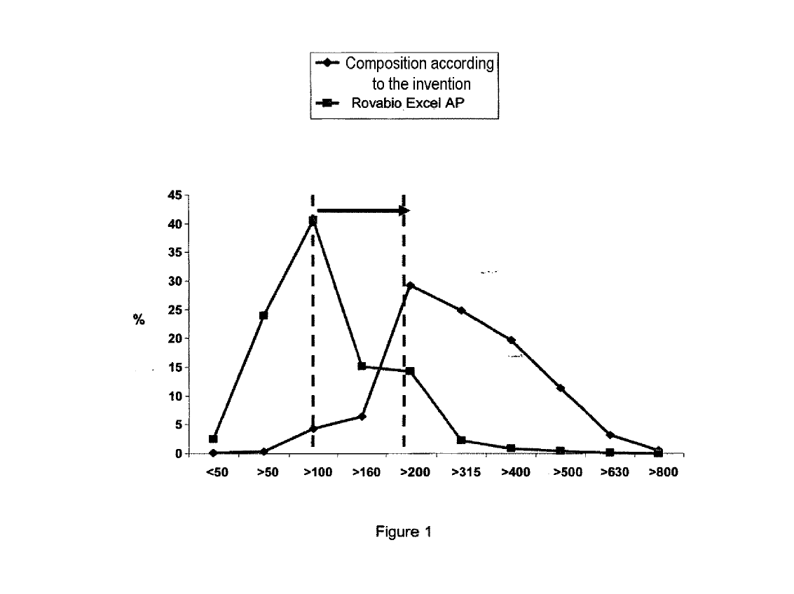

### See FIG. 1.

### 6. Other Measurements

The compressibility of the product Rovabio™ Excel AP is 22.1%, whereas the compressibility of the second composition is 3.4%.

### EXAMPLE 2

### Objective

The objective is to test in the granulation four enzymatic preparations added to a “growth” poultry feed base.

3 treatment temperatures at the conditioner outlet (80, 85 and 90° C.) are applied for each enzymatic preparation.

### Materials and Methods

### 1. Feed and Enzymes

200 kg of growth poultry meal feed are used to carry out these tests.

Four compositions in the powder form are tested. Each composition, corresponding or not corresponding to the criteria of the composition according to the present invention, is referred to as trial item.

The first composition is the product Rovabio™ Excel AP, which is provided in the powder form and comprises 19 enzymatic activities. This product is composed of 20% of wheat meal and of 80% of concentrated filtered fermentation must obtained from the fermentation of Penicillium funiculosum IMI 378536, which comprises 19 enzymatic activities.

The second composition was prepared according to the process described in example 1.

It is provided in the powder form with the particle size mentioned above and comprises 55% of carboxymethylcellulose, 25% of wheat meal and 20% of concentrated filtered fermentation must obtained from the fermentation of Penicillium funiculosum IMI 378536, which comprises 19 enzymatic activities.

The third composition was prepared according to the process described in example 1.

It is provided in the powder form with the particle size mentioned above and comprises 35% of carboxymethylcellulose, 45% of wheat meal and 20% of concentrated filtered fermentation must obtained from the fermentation of Penicillium funiculosum IMI 378536, which comprises 19 enzymatic activities.

The fourth composition was prepared according to the process described in example 1.

It is provided in the powder form with the particle size mentioned above and comprises 35% of carboxymethylcellulose, 45% of wheat meal and 20% of concentrated filtered fermentation must obtained from the fermentation of Penicillium funiculosum IMI 378536, which comprises 19 enzymatic activities.

### 2. Mixtures

Two mixtures of 60 kg of growth poultry feed are prepared using a paddle mixer with a horizontal axis rotating at 60 rev/min. The duration of each mixing is 2 minutes. Each mixed batch is emptied into a rectangular tank before being bagged up. A sample of approximately 1 kg representative of each mixture is withdrawn by bringing together 20 samples obtained by quartering in the rectangular tank.

See the table of the mixtures below.

| | | | Amount of | Amount of |
|---|---|---|---|---|
| | | | enzymatic | blank feed |
| | | | preparation | incor- |
| | TYPE | Composition in the powder | incorporated | porated |
| MIX- | OF | form and degree of | in each | in each |
| TURE | FEED | incorporation | mixture | mixture |
| A | Growth | Rovabio ™ Excel AP at | 3 g | 59.998 kg |
| | poultry | 50 g/T | | |
| B | | Composition according to | 3 g | 59.998 kg |
| | | the invention (55% CMC) | | |
| | | at 50 g/T | | |
| C | | Composition according to | 2 g | 39.998 kg |
| | | the invention (35% CMC) | | |
| | | at 50 g/T | | |
| D | | Composition according to | 2 g | 39.998 kg |
| | | the invention (35% CMC) | | |
| | | at 50 g/T | | |

### 3. Granulation

The granulation trials are carried out on a laboratory pellet mill having a flat die (Kahl 14-175 pellet mill of 3 kW).

For a growth broiler meal feed, the pellet mill die chosen for the trials will have channels with a diameter of 4 mm and a thickness of 24 mm (compression ratio: 6).

### 4. Drying-Cooling

For each granulation trial, a laboratory dryer-cooler is used to dry and cool the samples of hot granules collected at the die outlet.

The drying-cooling time is at least 5 minutes for a charge of hot granules of approximately 3.5 kg per cooler.

A sample of approximately 500 g representative of each manufacturing operation is withdrawn.

### 5. Measurements and Samplings Intended to Monitor the Granulation

The measurements and the samplings are carried out during the stabilized operation of the pellet mill (constant throughput, stable electrical power consumed and stable temperatures).

The measurements of water contents and die residence times are carried out starting from samples withdrawn during the stabilized phase of each trial.

The characterizations and parameters for carrying out pellet milling are noted and recorded during the trials.

### 6. Analytical Methods

### 6.1 β-Glucanase by the DNS Method

The assay is based on the enzymatic hydrolysis of barley β-glucan, a β-1,3(4)-glucan. The reaction products are determined by colorimetry, the increase in the reducing groups being measured using 3,5-dinitrosalicylic acid (DNS). The concentration of reducing sugar available after enzymatic hydrolysis is determined using a standard glucose curve, the absorbance of the glucose being measured at 540 nm. The calculated enzymatic activity is subsequently expressed in glucose equivalents.

A solution containing 1 ml of a β-glucan solution of the order of 1% (w/V) in a 0.1M sodium acetate buffer at pH 5.0 and 1 ml of solution of the enzyme at the appropriate dilution is incubated at 50° C. for 10 minutes. The enzymatic reaction is halted by the addition of 2 ml of a DNS solution (1% (w/V) of 3,5-dinitrosalicylic acid, 1.6% (w/V) of NaOH and 30% (w/V) of dextrorotatory sodium potassium tartrate in distilled water). The solution is homogenized, then placed in a refluxing water bath at 95° C. minimum and subsequently cooled in a bath to ambient temperature (over 5 minutes). Ten ml of ultrapure water are added to the solution and the absorbance is measured at 540 nm in a glass cell having an optical path length of 1 cm. The absorbance is corrected with that obtained for a reference solution to which the DNS is added before the enzymatic solution.

The results are converted into μmoles of reducing sugar by comparison with a range of standard solutions extending from 0.00 to 0.04% (w/V) of glucose, treated with DNS as in the case of the assays.

A unit of endo-1,3(4)-β-glucanase activity is defined as the amount of enzyme which produces 1 μmol of glucose equivalent per minute and per gram of product under the conditions of the assay (pH 5.0 and 50° C.).

### 6.2 Xylanase by the DNS Method

The assay is based on the enzymatic hydrolysis of birch xylan, a xylose polymer comprising β-D-1,4-bridges. The reaction products are determined by colorimetry, the increase in the reducing groups being measured using 3,5-dinitrosalicylic acid. The concentration of reducing sugar available after enzymatic hydrolysis is determined using a standard xylose curve, the absorbance of the xylose being measured at 540 nm. The calculated enzymatic activity is subsequently expressed in xylose equivalents.

A solution containing 1 ml of a 1% (w/V) solution of birch xylan in a 0.1M sodium acetate buffer at pH 5.0 and 1 ml of solution of the enzyme at the appropriate dilution is incubated at 50° C. for 10 minutes. The enzymatic reaction is halted by the addition of 2 ml of a DNS solution (1% (w/V) of 3,5-dinitrosalicylic acid, 1.6% (w/V) of NaOH and 30% (w/V) of dextrorotatory sodium potassium tartrate in distilled water). The solution is homogenized, then placed in a refluxing water bath at 95° C. minimum and subsequently cooled in a bath to ambient temperature (over 5 minutes). Ten ml of ultrapure water are added to the solution and the absorbance is measured at 540 nm in a glass cell having an optical path length of 1 cm. The absorbance is corrected with that obtained for a reference solution to which the DNS is added before the enzymatic solution.

The results are converted into μmoles of reducing sugar by comparison with a range of standard solutions extending from 0.00 to 0.04% (w/V) of xylose, treated with DNS as in the case of the assays.

A unit of endo-1,4-β-xylanase activity is defined as the amount of enzyme which produces 1 μmol of xylose equivalent per minute and per gram of product under the conditions of the assay (pH 5.0 and 50° C.).

### 6.3 Xylanase by the Viscometry Method

This method is specific to the determination of the endo-1,4-β-xylanase activity in feeds. Endo-1,4-β-xylanase hydrolyzes the xyloside bridges of xylan. The assay is based on the enzymatic hydrolysis of the xylose bridges of a solution of wheat arabinose, a β-1,4-xylan polysaccharide substituted with arabinose. The enzymatic activity is proportional to the reduction in viscosity of a wheat arabinoxylan solution in the presence of the enzyme to be quantitatively determined

A unit of endo-1,4-β-xylanase activity is defined as the amount of enzyme which will hydrolyze the substrate, reducing the viscosity of the solution, to give a change in the relative fluidity of 1 dimensionless unit per minute under the conditions of the analysis: pH 5.5 and 30° C.

### Results of the Trials

### 1. Setpoints for Adjustments

The setpoints for regulating the pellet mill are as follows:

Throughput: approximately 41 kg/h

Treatment temperatures at the conditioner outlet:

80, 85 and 90° C.

Temperatures experienced at the die outlet

Vapor pressure: 1.6 bar

Adjustment of the cutting height of the knives: 10 mm

### 2. Balance of the Enzymatic Activities

TABLE
Enzymatic activity (unit/g)

| | A | B | C | D |
|---|---|---|---|---|
| Level of CMC | 0 | 55% | 35% | 35% |
| Xylanase, DNS | 3810 | 4027 | 5344 | 5304 |
| Xylanase, visco | 31 053 | 30 293 | 32 273 | 31 153 |
| β-Glucanase, DNS | 4676 | 5265 | 6300 | 6081 |

It is found that the various formulations make it possible to retain the main reference enzymatic activities of the initial enzymatic concentrate.

### 3. Degree of Recovery of Xylanase Activity Measured by Viscometry on the Feeds After Passing Through the Pellet Mill at Different Temperatures

| | | Pellet mill treatment | | |
|---|---|---|---|---|
| | | temperature | | |
| | Level of CMC | 80° C. | 85° C. | 90° C. |
| A | 0 | 76% | 68% | 54% |
| B | 55% | 100% | 85% | 82% |
| C | 35% | 99% | 90% | 81% |
| D | 35% | 96% | 86% | 83% |

It is found that the xylanase activity of the standard product (A) is affected by the rise in temperature of the granulation conditions (losses of up to 46% at 90° C.). The various formulations tested make it possible to limit the loss in activity to less than 20%.

### EXAMPLE 3

### Objective

Study of the nutritional effects of Rovabio™ Excel AP and of a composition according to the present invention on the AME_{N} (nitrogen-corrected apparent metabolizable energy) value of a wheat-based feed for chickens of between 12 and 22 days.

### Material and Methods

### 1. Experimental Scheme

The animals used are male chicks of the Ross PM3 strain.

7 diets with 12 repetitions of 1 chick per cage, i.e. a total of 84 cages

The trials are randomized controlled trials.

The trial items comprise enzymatic activities potentially capable of improving the digestibility of a feed based on wheat and on corn in chickens.

TABLE
Experimental scheme

| Diets | | 1 | 2 | 3 | 4 | 5 | 6 | 7 |
|---|---|---|---|---|---|---|---|---|
| Bases | Starter | WCS (wheat corn soya) | | | | | | |
| | Growth | Wheat mixture | | | | | | |
| Products | | Control | Excel AP | Composition according | Composition according | Excel AP | Composition according | Excel AP |
| | | | | to the invention | to the invention | | to the invention | |
| Dose | g/t of | / | 50 | 50 | 50 | 50 | 50 | 50 |
| | feed | | | | | | | |

| | | | | | | | |
|---|---|---|---|---|---|---|---|
| Weight of feed to | 20 | 20 | 20 | 20 | 20 | 20 | 20 |
| be prepared (kg | | | | | | | |
| granules) | | | | | | | |
| Weight of feed to | 100 | 100 | 100 | 100 | 100 | 100 | 100 |
| be treated (kg | | | | | | | |
| meal) | | | | | | | |
| Number of test | 12 | 12 | 12 | 12 | 12 | 12 | 12 |
| subjects | | | | | | | |

### 2. Feeding Plan

The feeding plan was as follows throughout the trial.

TABLE
Feeds used during the study

| | D0-D12 | D12 to D18 | D19 to D22 |
|---|---|---|---|
| Period | Starter | Adaptation | Balance |
| Form | Ad libitum | Ad libitum | Ad libitum |
| Type of | Pre-experimental | Experimental | Experimental |
| feed | | | |
| Base | Wheat Corn/Corn | Wheat Soya/Corn Soya | Wheat Soya/Corn |
| | | | Soya |

### 3. Progression of the Experiment

The time sequence of the main operations is presented below:

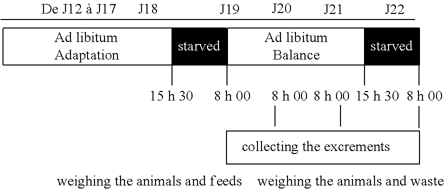

### Results

### 1. Feeds

TABLE
Analysis of xylanase enzymatic recovery
measured on the experimental feeds

| | | | Xylanase, visco (U/kg) | | |
|---|---|---|---|---|---|
| | | | Theoretical | Measured | Recovery |
| Diets | Feed | Treatment | content | content | (%) |
| 1 | Wheat | Control | 0 | 0 | / |
| 2 | Wheat | Excel AP1 | 1553 | 827 | 53% |
| 3 | Wheat | Composition 1 | 1647 | 1116 | 68% |
| | | according to the | | | |
| | | invention | | | |
| 4 | Wheat | Composition 2 | 2170 | 2408 | 111% |
| | | according to the | | | |
| | | invention | | | |
| 5 | Wheat | Excel AP2 | 1954 | 1647 | 84% |
| 6 | Wheat | Composition 3 | 2039 | 1602 | 79% |
| | | according to the | | | |
| | | invention | | | |
| 7 | Wheat | Excel AP3 | 1824 | 1570 | 86% |

The xylanase, visco, enzymatic activity values are greater than the recommendation of 1100 U/kg of feed for the feeds, except for diet 2.

### 2. Energy Digestibility

TABLE
Results of energy digestion by diet

| | | | | | | | | |
|---|---|---|---|---|---|---|---|---|
| | Diets | 1 | 2 | 3 | 4 | 5 | 6 | 7 |
| | Items | Control/ | AP1 | Inv 1 | Inv 2 | AP2 | Inv 3 | AP3 |
| | Dose Base | Wheat | 50 g/t | 50 g/t | 50 g/t | 50 g/t | 50 g/t | 50 g/t |
| AME_{N}* | Means | 3184a | 3238ac | 3231ac | 3300c | 3280bc | 3233ac | 3200ab |
| kcal/kg | Standard | 112.8 | 109.8 | 127.7 | 123.6 | 69.7 | 92.9 | 110.9 |
| DM | deviation | | | | | | | |
| | CV | 3.54 | 3.39 | 3.95 | 3.75 | 2.13 | 2.87 | 3.47 |
| | No. of | 12 | 12 | 12 | 12 | 12 | 10 | 12 |
| | values | | | | | | | |
| | Delta | | 54.0 | 46.2 | 115.9 | 95.5 | 48.9 | 15.8 |
| AME_{N}* | Means | 2913a | 2961ac | 2954ac | 3018c | 2998bc | 2958ac | 2928ab |
| kcal/kg | Standard | 102.1 | 100.4 | 115.8 | 111.6 | 63.7 | 84.7 | 100.1 |
| | deviation | | | | | | | |
| | CV | 3.51 | 3.39 | 3.92 | 3.70 | 2.12 | 2.86 | 3.42 |
| | No. of | 12 | 12 | 12 | 12 | 12 | 10 | 12 |
| | values | | | | | | | |
| | Delta | | 48.8 | 41.0 | 105.6 | 85.6 | 45.2 | 15.1 |

*Apparent metabolizable energy

All the items tested made it possible to improve the energy digestibility of the feed tested but with variable effectivenesses.

The improvements in AME_{N} are of a moderate level, reaching +105 kcal/kg DM approximately for composition 2 according to the invention.

Both types of composition have had the same effect on the AME measured. A second analysis was thus carried out per product.

TABLE
Results of energy digestion per product

| | Items | | | |
|---|---|---|---|---|
| | Dose | Control/ | Excel AP | Invention |
| | Base | Wheat | 50 g/t | 50 g/t |
| AME_{N} | Means | 3184 a | 3244 ab | 3256 b |
| kcal/kgDM | Standard | 112.8 | 97.8 | 118.3 |
| | deviation | | | |
| | CV | 3.54 | 3.02 | 3.63 |
| | No. of values | 12 | 48 | 36 |
| | Delta | | 59.3 | 71.6 |
| AME_{N} | Means | 2913 a | 2966 ab | 2978 b |
| kcal/kg | Standard | 102.1 | 88.9 | 107.3 |
| | deviation | | | |
| | CV | 3.51 | 3.00 | 3.60 |
| | No. of values | 12 | 48 | 36 |
| | Delta | | 53.5 | 65.0 |

This second analysis shows that, taken as a whole, the T-Flex items according to the invention have improved the energy digestibility of the feed tested. On the other hand, the improvement obtained with the Excel AP items is not significant, despite a strong tendency (p=0.06).

### 3. Growth Performances

TABLE
Results for growth from D12 to D22

| | | | | | | | | |
|---|---|---|---|---|---|---|---|---|
| | Diets | 1 | 2 | 3 | 4 | 5 | 6 | 7 |
| | Items | Control/ | AP1 | Inv 1 | Inv 2 | AP2 | Inv 3 | AP3 |
| | Dose Base | Wheat | 50 g/t | 50 g/t | 50 g/t | 50 g/t | 50 g/t | 50 g/t |
| Weight at | Means | 322 | 324 | 324 | 324 | 324 | 323 | 323 |
| the | Standard | 22.1 | 21.2 | 21.1 | 22.2 | 20.8 | 21.6 | 22.4 |
| beginning | deviation | | | | | | | |
| of | CV | 6.9 | 6.5 | 6.5 | 6.9 | 6.4 | 6.7 | 6.9 |
| Adaptation | | | | | | | | |
| (g) | | | | | | | | |
| Weight at | Means | 663 | 686 | 685 | 676 | 681 | 681 | 675 |
| the end of | Standard | 79.4 | 65.5 | 50.6 | 50.2 | 40.4 | 45.7 | 35.7 |
| Balance | deviation | | | | | | | |
| (g) | CV | 12.0 | 9.5 | 7.4 | 7.4 | 5.9 | 6.7 | 5.3 |
| Weight | Means | 341 | 362 | 361 | 352 | 356 | 358 | 352 |
| gain D12-D22 | Standard | 62.8 | 49.8 | 37.7 | 37.4 | 33.9 | 32.2 | 34.5 |
| (g) | deviation | | | | | | | |
| | CV | 18.4 | 13.7 | 10.5 | 10.6 | 9.5 | 9.0 | 9.8 |
| Consumption | Means | 665 | 672 | 674 | 649 | 656 | 671 | 658 |
| D12-D2 2 | Standard | 104.6 | 75.0 | 64.7 | 51.7 | 45.9 | 62.6 | 49.8 |
| (g) | deviation | | | | | | | |
| | CV | 15.7 | 11.2 | 9.6 | 8.0 | 7.0 | 9.3 | 7.6 |
| FC* D12-D22 | Means | 1.96 a | 1.86 b | 1.87 b | 1.85 b | 1.85 b | 1.88 b | 1.87 b |
| | Standard | 0.108 | 0.066 | 0.076 | 0.107 | 0.073 | 0.073 | 0.071 |
| | deviation | | | | | | | |
| | CV | 5.510 | 3.558 | 4.038 | 5.774 | 3.958 | 3.898 | 3.793 |
| | Delta % | | −5.1 | −4.7 | −5.8 | −6.0 | −4.5 | −4.7 |

*Feed Conversion

In contrast to what was observed for the energy digestibility, the items tested virtually all had a significant effect on the growth performances (feed conversion) over the total study period (12 to 22 days). The compositions according to the invention (Inv 1, Inv 2 and Inv 3) and the Rovabio™ Excel AP compositions (AP1, AP2 and AP3) contributed virtually the same improvement in conversion.

### 5. Conclusion

All the items tested on a wheat-based feed had an effect on the AME of the feed tested. The improvements obtained are moderate. Taken as a whole, the products according to the invention significantly improved the AME of the feed.

The growth performances and in particular the performances with regard to the feed conversion over the overall period (D12-D22) were greatly and significantly improved with all the products.

1. A heat-resistant composition capable of being obtained by the process comprising the following steps:
a) codrying the following compounds:
a support chosen from the group consisting of wheat meal, starch, gypsum, maltodextrin and corncobs, and
a mixture in the liquid form of at least two enzymes, so as to obtain an intermediate base,
b) granulation by impregnation of the intermediate base with a coating agent chosen from the group consisting of cellulose and its derivatives, chitin, carrageenan, sodium alginate, plant gums, gums obtained by fermentation and starches and derivatives,
c) coating the impregnated intermediate base with a coating agent chosen from the group consisting of cellulose and its derivatives, chitin, carrageenan, sodium alginate, plant gums, gums obtained by fermentation and starches and derivatives, and
d) drying the coated impregnated intermediate base.

2. The heat-resistant composition as claimed in claim 1, in which the mixture in the liquid form of at least two enzymes is obtained from the fermentation of just one microorganism.

3. The heat-resistant composition as claimed in claim 1, in which the mixture in the liquid form of at least two enzymes is obtained from the fermentation of two different microorganisms.

4. The heat-resistant composition as claimed in claim 1, comprising:
a) from 15 to 50% by weight of said mixture of at least two enzymes,
b) from 25 to 60% by weight of said support,
c) from 25 to 60% by weight of said coating agent.

5. The heat-resistant composition as claimed in claim 1, according to which the coating agent is carboxymethylcellulose.

6. The heat-resistant composition as claimed in claim 1, in which the mixture in the liquid form of at least two enzymes is a concentrated filtered fermentation must obtained from the fermentation of at least one microorganism.

7. The composition as claimed in claim 1, in which the at least two enzymes are chosen from the group consisting of a xylanase, a β-glucanase, a cellulase, a pectinase, a phytase and a protease.

8. The composition as claimed in claim 1, in which the at least two enzymes are chosen from the group consisting of phytase, endo-1,4-β-xylanase, α-arabinofuranosidase, β-xylosidase, feruloyl esterase, endo-1,5-α-arabinanase, endo-1,3(4)-β-glucanase, laminarinase, endo-1,4-β-glucanase, cellobiohydrolase, β-glucosidase, polygalacturonase, pectin esterase, rhamnogalacturonase, aspartic protease, metalloprotease, endo-1,4-β-mannanase, β-mannosidase and α-galactosidase.

9. The composition as claimed in claim 1, in which the microorganism is Penicillium funiculosum deposited at the IMI (International Mycological Institute, Bakeham Lane, Englefield Green, Egham, Surrey, TW20 9TY, UK) on Mar. 24 1998 under the number IMI 378536.

10. The composition as claimed in claim 1, in which the coating agent is carboxymethylcellulose or ethylcellulose.

11. An animal feed, characterized in that it comprises a nutritional base for animals and a composition as claimed in claim 1.

12. The use of a composition as claimed in claim 1 in the preparation of a nutritional additive for animals in the granular powder form.

13. The use of a composition as claimed in claim 1 in the preparation of an animal feed, characterized in that the feed comprises a nutritional base for animals and a nutritional additive.
